(19) United States
(12) Patent Application Publication
(10) Pub. No.: US 2008/0320407 A1
(43) Pub. Date: Dec. 25, 2008

(54) Method for Processing Data

(76) Inventor: Jorg Muller, Sulzetal (DE)

Correspondence Address: SALTER & MICHAELSON;THE HERITAGE BUILDING, 321 SOUTH MAIN STREET, PROVIDENCE, RI, 029037128, US

(21) Appl. No.: 12/064,688

(22) PCT Filed: Aug. 24, 2006
(86) PCT No.: PCT/EP2006/008317

§ 371 Date: Jun. 25, 2008

(30) Foreign Application Priority Data
Aug. 24, 2005 (DE) 10 2005 040 240.2

(51) Int. Cl. G06F 3/048

(52) U.S. Cl. 715/771

(57) ABSTRACT

The invention relates to a method for processing data, said method comprising a plurality of steps. A plurality of data sources are provided. At least one data access method is provided for accessing the individual data sources, said data sources providing a homogeneously reprocessable data structure. The individual data sources are symbolised on a user interface of a data processing installation, visible to the user. Combination method modules are used to combine data supplied thereto from the homogeneously reprocessable data structures of the data sources or from the results of other combination method modules, and enable a reproduction of the results. The combination method modules are symbolised on the user interface. A method module is used to output or reprocess the results. Said method module for outputting or reprocessing the results is symbolised on the user interface. Any arrangement of the data source symbols and combination method module symbols and the output symbols on the user interface in relation to each other is possible. The arrangement also reflects the sequence of the individual data processing steps.

The invention relates to a method for processing data wherein the data from a plurality of data sources is made available to a user for further processing.

Data sources exist in numerous forms. Even within an individual company, there are software solutions of the most diverse type that make available different data bases, which are each optimised for specific results. If new problems arise, new software programs are generally developed therefor, new data bases are conceived and they are supplied with data, new types of application are created from the existing data bases by means of a fresh programming process, and so on.

A considerable amount of know-how is necessary for each of these steps. Very often, a user who is not exactly a specialist in this field places heavy demands on the appropriate specialists in his company or else on externally retained consultants when they cannot be satisfied by the existing software-tools and programs, and these then have to be reprogrammed at great, expense.

Frequently however, the programs developed in such a way are extremely complicated and difficult to run and may not even be usable at all by the non specialized user.

This often leads to frustration in practice. Certain requirements are not fulfilled since they are technically too complex or else are too expensive in relation to the problem that is to be solved or because the corresponding programming process would last too long and the problem would then have already been resolved in another way.

The software solutions developed in such a way are also frequently unusable by the non-specialized user. The end user does not understand the underlying concepts or does not find the guidance manual clear. This effect is enhanced if the results are not plausible or cannot be re-created because the end user simply cannot understand the basis upon which the results presented by the software could actually have been developed. In this case too, end user confidence in the software solution that has been provided to them is frequently lost.

Solutions are already known for individual aspects of the thus ensuing problems.

Thus, U.S. Pat. No. 5,426,780 proposes a system for the dynamic segmentation of geographical information from so-called GIS data bases. Here, the user is supported by a highly specialized interface for the production of a technical query language for the special evaluation of such GIS data bases. Here, the target group of users interested in such geographical information receives a technically simplified representation of the result. Nevertheless, the user must have a very large amount of background knowledge in regard to this data; it is not possible to transfer this over to other types of problem.

From CA 2 200 924 C, there is known a tool the user interface of which is intended to put the user into a position where he can investigate data sets in graphic form. With the help of this tool, a very large volume of data can be divided into a large number of smaller data extracts and thus enable it to be analysed in a comparatively shorter time. These smaller data extracts can then be further processed.

This method is of particular help for the specialist, but less so for the end user.

EP 1 482 417 A1 describes data processing methods and systems with the aid of which different tables of data bases can be combined with one another. The processes for the procurement of data from different physical data sources and the standardization thereof for later evaluation by software applications are described in such a way.

Hereby, it is proposed that the extraction and standardisation processes be effected by transformation as well as storage of the data in a separate data base, whereby the data base here is of the so-called data warehouse type, in particular, the transportation of the data is effected asynchronously and complex infrastructures are solved by programming them individually. The separately developed uniform data base, the data warehouse, then finally places all the needed data from the other data sources ready for the end user. In the long run, the end user can only fall back on this data warehouse, all other processes such as occur in the state of the art remain hidden to him and also they can neither be updated nor modified without calling in the assistance of a specialist.

From EP 1 191 462 AI, a method for combining non-similar data sources is known. The intention is to enable different table formats to be combined with one another. Described here, are some fundamental mechanisms which are needed in a data warehouse in order to enable data to be rapidly evaluated and then found again. The basic idea is to build up an index of like attributes and thus find a combination. The structure thus becomes quite fixed and invariable.

All these solutions are possibly well suited to their special application of use, but they do not provide a solution for an end user who would like to use different data sources and interconnect them in real time in the most diverse of manners without always having to draw on the assistance of a programmer or some other specialist in each individual case.

Consequently, the object of the invention is it to propose such a method for the processing of data.

In accordance with the invention, this object is achieved by a method for processing data, comprising the following steps: providing a plurality of data sources; symbolizing the individual data sources on a user interface of a data-processing system that is accessible to a user; providing one or more data access procedures to the individual data sources which make available a uniform further-processable data structure; providing combination method modules which can produce a combination of the data supplied thereto from the uniform further-processable data structures of the data sources or of the results from other combination method modules and enable the results to be passed on; symbolizing the combination method modules on the user interface; providing a method module for outputting the results or for the further processing of the results; symbolizing the method module for outputting the results or for the further processing of the results on the user interface; and enabling an arbitrary arrangement of the data source symbols and the combination method module symbols and the outputting symbols on the user interface relative to each other, whereby the arrangement simultaneously reflects the execution of the individual data processing steps.

The problem can be solved in a surprising manner by a concept of this type. In a preferred embodiment hereby, provision is made for the user interface to be a graphical interface on a display screen in the data-processing system.

Thus, for example, one can imagine the end user as being someone working in the marketing or sales department of a company. Various different data sources, the concrete technical structure of which does not necessarily need be known to him, are available to him. There may be data bases containing customer data, a further data base of a completely different nature which is concerned with company contracts, a data base which contains the so-called Robinson list, further data bases with address and telephone data which are possibly bought in from public sources, and then possibly, data bases which are made available in individual cases by credit information bureaus for instance, and so on.

Each of these individual data sources which the company can make available to him in real time is symbolized on his user interface. The end user can more or less appreciate the sort of data that he can obtain from this data base if he so wishes.

Apart from these data sources, there are also data access procedures at his disposal which can extract a specific data structure from these individual data sources, whereby this structure is capable of being further-processed in a uniform manner. For this purpose, there are various methods which are also described inter alia in the aforementioned publications from the state of the art for example. If a certain data source is available to the end user for his use, then naturally such a data access procedure can also be made directly available to him. For the end user, it is not crucial as to how this procedure works.

Of more importance to him is that combination method modules are readily available to him. With the aid of these modules, it is possible to combine together data from each of two of the data sources or two subsets of data from the same data source. More precisely expressed, the items of data derived from the uniform further-processable data structures are combined together thereby and, after the combining process, the results are passed on.

Such combination method modules can operate in many different ways. They are in each case likewise available to the user in the form of symbols on the user interface.

Finally, there is a method module for outputting the results or for the further processing of the results. This too is symbolized on the user interface and is available to the user for his use.

The user now has the possibility of logically connecting each of the symbols for the data sources or the combination method modules or for the outputting process to one another. Here, the execution thereof on the user interface is apparent to him in a very simple manner. The technical processing steps behind these symbols are of no interest to him here. Provision is however made for these process steps to be run exactly in the light of the arrangement of the symbols.

This process, which one can also refer to as modelling or as a “process of data modelling”, is thus carried out by the end user. The end user indicates which of the data sources he would like to use at any given moment, how he wants to combine them and which items of data he would like to output at the end of the operation. All of this is comprehensible to him and is plausibly illustrated on the user interface without him even having to have any programming ability or special technical knowledge.

The entire process is up-to-date. Since the procedures only run during the modelling process, the data sources are also used in the state in which they are then in. Thus, in contrast to the conventional use of a data base in the form of a data warehouse, it is no longer necessary to perhaps first build up this data base in the responsible specialized department of the company and provide it with data which is extracted from other data sources, and then, for instance, let the sales manager work with this data base that was current at the point in time when it was set up, but which, at the time when it is put to use, is already outdated again. Instead, the most recent values are brought together on the user interface of the end user and these current items of data are ‘mixed’ by him and then supplied to the output.

This output may, for example, be a simple list with information for a call centre which contacts previously concretely and carefully selected agents for customers having a special problem.

In one preferred embodiment of the invention, a hierarchical representation of categories and pre-configured nodes is employed. Nodes, which are available on the user interface, on his display screen for instance, have already been equipped ab initio with a pre-configuration by the programmer. The operator or user can then insert the type of node that he has selected into the modelling interface by a double-click action or by techniques in the form of drag and drop for example. Here, it is not just the node that is inserted into the display screen interface, but the appropriate associated process is also actually configured automatically simultaneously. In this way, the procedure for the configuration of the node that is necessary for the execution of the entire process is in fact removed from the operator and user or else, it is substantially simplified. This reduces the special demands that are placed on the user and shifts them onto the steps which are to be taken for making the process available.

An example of the type of node used for a data source will now be given in order to clarify this manner of approach. Thus, for example, the pre-configuration could contain the selection for “all the customers of the marketing branch”. This characteristic of the node namely to show “all the customers of the marketing branch” that is to be passed on or made available, is assigned to the node as a pre-configuration and made available by the programmers. This configuration would be regularly maintained when the program is used over a long period of time. The operator and user does not however, need to take any interest in this process. These characteristics are automated and made available without any further effort on his part. The operator and user can thus immediately begin or continue with the modelling process in that he inserts the node accordingly on his user interface at the position he wants for the execution of the process.

It could also concern very complex evaluation processes which serve completely different purposes.

It is of special advantage that the end user can also bookmark together certain particularly large modules that prove meaningful to him on a regular basis into the form of a grand module consisting of data sources, combination method modules and further steps. He can then combine this “package” with respective further variable elements in order to serve the particular purposes of some other current application.

A further advantage consists in that additional data sources that are made available in the company over the course of time can be absorbed comparatively easily. These new data sources can then be immediately employed by the end user without further auxiliary knowledge. He can then subject them to further processing using the same combination method modules that are in any case already at his disposal.

As far as he is concerned, the current customer lists do not even change on his user interface since they inevitably always represent the current position.

The technically less experienced user does not have to take into consideration any of the technical restrictions when he is data modelling on the user interface.

The creativity of the end users when seeking a solution to problems being presented thereto is no longer inhibited. Until now, the end users were often resigned and regarded their requirements as unsolvable since they were dependent at each step on someone who solved the requirement by means of a new program. This problem no longer exists.

Other than is the case for so called conventional OLAP Tools (Online Analytical Processing), he is also no longer restricted to preparing certain code numbers but can concentrate on the common data sources that are available to him and he can also use them.

With the aid of the method in accordance with the invention for example, data from different systems, perhaps from various SAP and non SAP systems, can be selected. These selected items of data can be combined with one another and the results of the selection ensuing thereby can subsequently be exported to differing further processing systems.

This concept differs considerably from other known procedures. In the foreground, there is the skilled operator and user who would like to analyse and combine the information from different data sources. Knowledge in regard to the technical origin and the interdependencies of the data sources is of hardly any interest to this skilled user and in particular too, he does not want to be confronted with the technical requirements. The method in accordance with the invention actually enables him to relegate this technical origin and the interdependencies of the data sources to a subordinated role when modelling his data.

The data modelling process can be effected with real time data and is still capable of being handled in an interactive communication even with very large sets of data of more than 100,000 data records.

The procedures in accordance with the invention for instance support a simple import and export process into the usual spread-sheet programs, whereby interfaces for various SAP systems can be made available. Simultaneously, a simple connection with external systems, not in accord with SAP perhaps, is still ensured.

The method does not stand in the way of background execution without interactive dialogue (batch capability).

Fields of application are, for example, selections in marketing and sales, data analysis by departments in the IT sector and data migration from external systems.

In the following, an exemplary embodiment of the invention is described in more detail with the aid of the drawing.

### Therein:

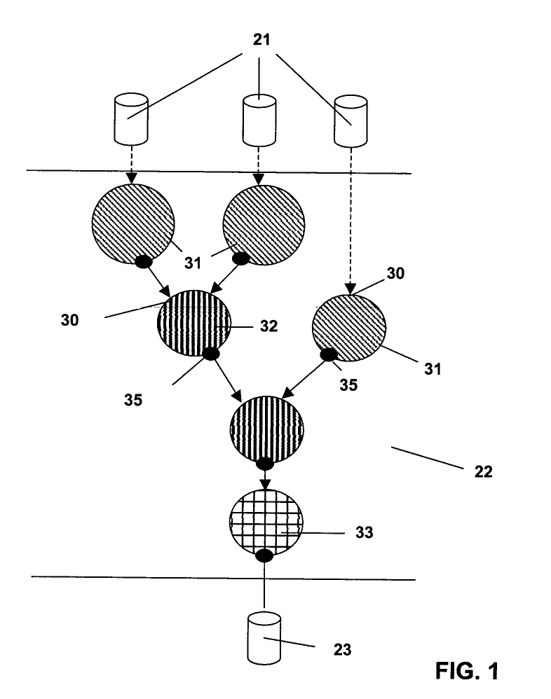

FIG. 1 shows a schematic example of the result of a data modelling process which is undertaken with the method in accordance with the invention;

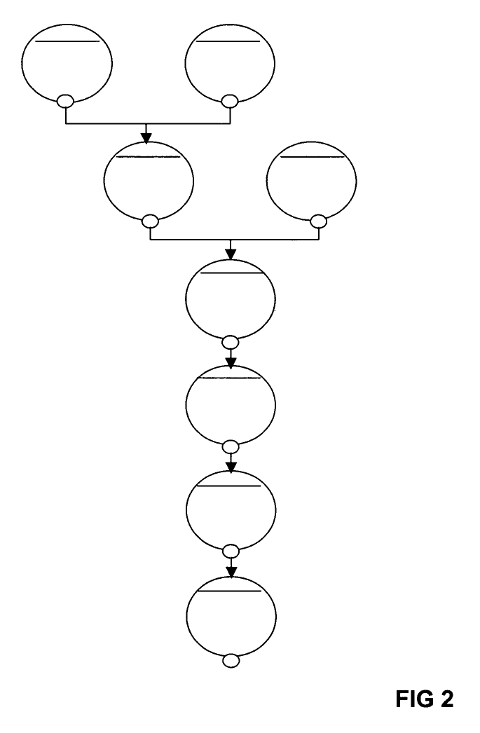

FIG. 2 a concretised embodiment of a method in accord with FIG. 1; and

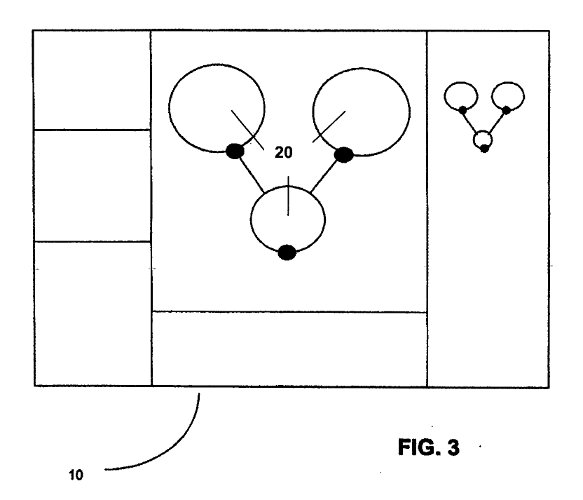

FIG. 3 an example of an actual, representation on a user interface.

A graphical representation on a user interface 10 of a display screen is particularly suitable as the most appropriate provision and symbolization for the different elements of the method in accordance with the invention. In particular, nodes 20, which can be configured as different types of node, can be provided for the various symbols. These types of node can be expressed such as to be mutually distinguishable for the user by differing shapes or colours and symbolize nodes 31 for data sources or nodes 32 for combination method modules or nodes 33 for outputting modules or other types of node. The types of node are described in more detail in the further course of the description.

In FIG. 1, the different colours or shapes are made recognizable by means of hatchings that serve for making the various types of node 31, 32, 33 distinguishable from each other. Here however, there are numerous other possibilities available for the purposes of making a distinction and identification.

Preferably, each node could also be described with words which the end user can freely select and thus document the meaning that these nodes have for the user.

Here, each node 20 is configurable in dependence on its meaning by virtue of which its behaviour can be affected. A node can have one or even several inputs 30 for data, moreover, it hag a result output 35 via which the results developed in the node are passed on.

Apart from these nodes 31, 32, 33, which help to clarify things for the user when processing his data, FIG. 1 shows the symbols for one or more real data sources 21 and the real system 23 for the further processing of the results.

In the graphical representation in the Figures selected here, the symbol 21 for a data source is shown in the form of a cylinder. Moreover, an arrangement extending from top to bottom which appears logical to the end user is selected. Naturally, in dependence on his graphical tastes, another arrangement or a completely different representation of the symbols could also be effected. In the selected representation, the symbolized nodes 22 follow the real data sources 21 on the modelling interface. These symbolized nodes 22 are provided in the above mentioned types of node 31, 32 and 33.

Nodes 23 which symbolize a real, actual data export into a real data set are indicated below.

Behind each of the symbols, there lies a certain method step as will be discussed hereinafter. On his user interface 10, the operator or user only sees the region between the two horizontal lines in FIG. 1. The regions above and below these lines are additionally shown in the illustration for explanatory purposes in order to additionally clarify the function lying behind the user interface 10.

The end user therefore sees on his user interface 10 only the symbols 22, i.e. the nodes 31, 32, 33. He does not see the real data source 21 and the real further processing system 23 as such. However, they are represented by the symbols or types of node 31 or 33 on the user interface 10.

The end user can now combine the various nodes 31, 32, 33 with one another by connecting the outputs 35 and inputs 30 of the nodes to one another in such a way as he would like this logically to be. Hereby, nodes can access the result outputs of preceding nodes. Depending upon the type of node and the meaning, a node can receive no, one or else several logical interconnections to preceding nodes.

Essential types of node, are a data source 31, a combination method module 32 and an outputting module 33. The type of node 31 relating to a data source provides the results from a data source, for example, the tables in a data base with selection parameters. It refers back to a real data source 21 for this purpose. This is symbolized by a broken line in FIG. 1.

The output results can be affected by the configuration of this node 31, which means that additional conditions can be used to limit the number of results.

This type of node 31 cannot receive connections to preceding nodes, apart from its previously mentioned recourse to the real data source 21.

A type of node which symbolizes a combination method module 32 can receive and combine together the output results 35 from other nodes 31, or even from 32 serving as an input 30. The output result 35 is the result of the combination of exactly two preceding nodes in the described embodiment.

The manner in which the results from the two preceding nodes are to be combined with one another can be affected by the configuration.

An output module 33 or the node symbolizing this output module provides a way for passing on the output results 35 from the preceding nodes to a further processing system, whereby this further processing could also be a print-out, a representation on a display screen or even a completely different type of further processing system. In the illustration, this real further processing system adjoins the output module 33 in the form of a cylindrically illustrated node 23.

The kind of further processing required can be specified by the configuration of this output module 33.

This type of node 33 can receive as many connections to preceding nodes as desired.

Further types of node are in principle possible. Thus, a node can be in the form of a filter module with the aid of which the results from preceding nodes can be subjected to certain additional filtering criteria that are usually of a general type or are especially developed for this case. In this case, the output result 35 of this node contains all the results from the preceding node without the filtered data records.

However, upon closer inspection, such a filter node is a modification of an additional data source which possesses these filter properties. Thus, for example, the Robinson list can be defined either as a data source 21 and used as a node 31, or it can be employed as a filtering criterion. This is less relevant for the end user so that practicable solutions can be selected here.

The data sources 31 themselves could also either be pre-filtered so that from the very beginning, a data source only contains the data records which relate to a certain class of goods for example. Alternatively, the filtering step could also be applied to the already unified data structure.

If it is being employed, this type of node can, in like manner to the node of type 31, receive exactly one connection to a preceding node.

A further node can be employed as a finishing or refinement module. The results from a preceding node can be enriched with additional details by means of this type of node. In end effect here too, it is an additional data source from which these additional details can be extracted.

This type of node can also receive exactly one logical connection to a type of node.

Finally, one can select a collection-type node as an additional type of node. This type of node offers the end user the opportunity to reuse earlier data modellings or those data modellings using several nodes that he has previously produced. Here, the earlier modelling is then illustrated in the form of a node.

In accord with the inventive concept, the procedure for the data modelling itself is such that one or more data sources of the type 21 make their results available through nodes of the type 31. The user models these items of data by inserting and logically interconnecting further nodes.

At the conclusion of the modelling process, he then passes on the result to the further processing system 23 via one or more nodes 33 of the output module type. This is symbolically illustrated in FIG. 1 by means of the three data sources 31 and two combination method modules 32 that are logically linked to the data sources and an output module node 33.

In FIG. 2, there is shown another example with the aid of which one possible use of the invention is depicted, this, for instance, having been created on his laptop by an end user from the various possibilities available to him.

Two of the data sources used by the end user are indicated above, wherein the left hand data source contains all the customers of the company in the branch “marketing” and the right hand data source all the orders which the company has received within a certain time period for articles in the group of goods “X”.

The items of data that are already located in a data structure for the purposes of further processing are supplied to a combination method module which forms therefrom those customers who have bought articles from the group of goods “X”.

This result is then combined in turn with a third data source which contains the names of company staff in the purchasing departments having the function of ‘departmental manager’.

A combination of these items of data in a second combination method module results in all those departmental managers of customers who have bought articles from the group of goods “X”.

There then follows a filtering process in accord with the Robinson list for example in a filter module, whereby here those data records which drop out in accordance with this filtering criterion are deleted.

Subsequently, the data records then remaining are supplemented by additional address and communication data in a finishing module. Here, as already explained above, this may be an additional data source which is combined with the data.

The results from this node are then transferred to an output module which exports the hits to a phone list and passes this on to a call centre.

A display screen, such as it would appear to the user, is illustrated very schematically in FIG. 3. The rectangular surface symbolizes a user interface on a conventional display screen such as a sales manager for instance frequently has in front of him. The data modelling which was discussed in FIG. 1 or 2 is indicated exactly in the middle field in exemplary manner.

On the right, it is possible to have an overview which is in the form of a further representation of the modelling work area, but on a greatly reduced scale. Although this is not particularly helpful in the exemplary embodiment illustrated, it would so be in the case where the data modelling character shown in the central, middle part is very complex and is no longer capable of being represented in its entirety on the display screen.

Additional information can also be indicated below the modelling work area, perhaps in the form of explanations and auxiliary indications such as indications as to the update status of the consulted data sources and the like. This area can also be blanked out if necessary.

The possibilities available to the end user are entered on the left hand side of the modelling work area of the user interface. He can arrange these in the modelling work area at a position he so desires by means of “drag and drop” techniques for example or he can click and select them in another form.

Three areas are selected in the embodiment illustrated here. The lowest area places all the possibilities that the end user can employ at his disposal, i.e. all the available data sources, the combination method modules with their respective possibilities and finally also the output modules, i.e. the type and form required for the process of outputting to a further processing system, perhaps for printing, display on a display screen or for some other purposes.

Frequently however, the end user will want to make a selection that is not at all in terms of the possibilities he has in regard to the data sources etc., but rather, in terms of the particular category from which these have originated. Naturally, nested categories and pre-configured possibilities can also be envisaged here. One would indicate these within the rectangular area in the centre on the left hand side.

Finally, within the highest area on the left hand side, the end user himself can select those favourites of his that he perhaps might need particularly frequently and would therefore like to consult for preference.

### LIST OF REFERENCE SYMBOLS

10 user interface
20 nodes
21 real data sources
22 symbolized nodes on the modelling interface
23 results of the modelling process in a real further processing system
30 inputs of the nodes
31 nodes for data sources
32 nodes for a combination method module
33 nodes for an output module
35 outputs of the nodes

1. Method for processing data; comprising the following steps:
a) providing a plurality of real data sources;
b) providing one or more data access procedures to the individual real data sources which make available a uniform further-processable data structure;
c) symbolizing the individual real data sources by the uniform further-processable data structures on a user interface of a data-processing system that is accessible to a user;
d) providing combination method modules which can produce a combination of the data supplied thereto from the uniform further-processable data structures of the data sources or of the results from other combination method modules and enable the results to be passed on;
e) symbolizing the combination method modules on the user interface;
f) providing a method module for outputting the results to a real further processing system;
g) symbolizing the method module for outputting the results to a real further processing system on the user interface; and
h) enabling a desired arrangement of the data source symbols and the combination method module symbols and the outputting symbols on the user interface relative to each other, whereby the arrangement simultaneously reflects the execution of the individual data processing steps.

2. Method in accordance with claim 1, characterized
in that the user interface is a graphical interface on a display screen in the data-processing system.

3. Method in accordance with claim 1, characterized
in that the nodes of various types of node are symbolized on the user interface and highlighted for the user by the use of mutually distinct colours and/or shapes.

4. Method in accordance with claim 3, characterized
in that the nodes of differing type that are depicted in various colours and/or shapes can be arranged by the user in such a way that symbols, which represent the uniform further-processable data structures of the real data sources are arranged on one side of the user interface, and
in that symbols, which represent the method modules for the output to a real further processing system, are illustrated on the other side of the user interface.

5. Method in accordance claim 1,
characterized
in that the nodes are programmed with pre-configurations and are made available to the user on the user interface, and
in that, by modelling and shifting the nodes on the user interface, the user inserts the respectively assigned pre-configuration into the overall modelled configuration not only on the user interface, but also automatically thereby in the processing of the data.

6. Method in accordance with claim 1,
characterized
in that there are provided filter modules which undertake filtering of the data from the uniform further-processable data structures of the data sources or the results from the combination method modules;
in that the filter modules are symbolized on the user interface;
in that the symbols for the filter modules can be arranged relative to each other on the user interface in such a way that they reflect the execution of the filtering steps.

7. Method in accordance with claim 1,
characterized
in that there are provided finishing or refinement modules which undertake enrichment of the data from the uniform further-processable data structures of the data sources or the results of the combination method modules;
in that the finishing or refinement modules are symbolized on the user interface; and
in that the symbols for the finishing or refinement modules can be arranged relative to each other on the user interface in such a way that they reflect the execution of the enrichment steps.

8. Method in accordance with claim 1,
characterized
in that collection modules, which represent a summary of earlier or previously produced data modellings using a plurality of nodes, are provided as a type of node.

9. Method in accordance with claim 2,
characterized
in that the nodes of various types of node are symbolized on the user interface and highlighted for the user by the use of mutually distinct colours and/or shapes.

10. Method in accordance claim 2,
characterized
in that the nodes are programmed with pre-configurations and are made available to the user on the user interface, and
in that, by modelling and shifting the nodes on the user interface, the user inserts the respectively assigned pre-configuration into the overall modelled configuration not only on the user interface, but also automatically thereby in the processing of the data.

11. Method in accordance claim 3,
characterized
in that the nodes are programmed with pre-configurations and are made available to the user on the user interface, and
in that, by modelling and shifting the nodes on the user interface, the user inserts the respectively assigned pre-configuration into the overall modelled configuration not only on the user interface, but also automatically thereby in the processing of the data.

12. Method in accordance claim 4,
characterized
in that the nodes are programmed with pre-configurations and are made available to the user on the user interface, and
in that, by modelling and shifting the nodes on the user interface, the user inserts the respectively assigned pre-configuration into the overall modelled configuration not only on the user interface, but also automatically thereby in the processing of the data.

13. Method in accordance with claim 2,
characterized
in that there are provided filter modules which undertake filtering of the data from the uniform further-processable data structures of the data sources or the results from the combination method modules;
in that the filter modules are symbolized on the user interface;
in that the symbols for the filter modules can be arranged relative to each other on the user interface in such a way that they reflect the execution of the filtering steps.

14. Method in accordance with claim 3,
characterized
in that there are provided filter modules which undertake filtering of the data from the uniform further-processable data structures of the data sources or the results from the combination method modules;
in that the filter modules are symbolized on the user interface;
in that the symbols for the filter modules can be arranged relative to each other on the user interface in such a way that they reflect the execution of the filtering steps.

15. Method in accordance with claim 4,
characterized
in that there are provided filter modules which undertake filtering of the data from the uniform further-processable data structures of the data sources or the results from the combination method modules;
in that the filter modules are symbolized on the user interface;
in that the symbols for the filter modules can be arranged relative to each other on the user interface in such a way that they reflect the execution of the filtering steps.

16. Method in accordance with claim 5,
characterized
in that there are provided filter modules which undertake filtering of the data from the uniform further-processable data structures of the data sources or the results from the combination method modules;
in that the filter modules are symbolized on the user interface;
in that the symbols for the filter modules can be arranged relative to each other on the user interface in such a way that they reflect the execution of the filtering steps.

17. Method in accordance with claim 2,
characterized
in that there are provided finishing or refinement modules which undertake enrichment of the data from the uniform further-processable data structures of the data sources or the results of the combination method modules;
in that the finishing or refinement modules are symbolized on the user interface; and
in that the symbols for the finishing or refinement modules can be arranged relative to each other on the user interface in such a way that they reflect the execution of the enrichment steps.

18. Method in accordance with claim 3,
characterized
in that there are provided finishing or refinement modules which undertake enrichment of the data from the uniform further-processable data structures of the data sources or the results of the combination method modules;
in that the finishing or refinement modules are symbolized on the user interface; and
in that the symbols for the finishing or refinement modules can be arranged relative to each other on the user interface in such a way that they reflect the execution of the enrichment steps.

19. Method in accordance with claim 4,
characterized
in that there are provided finishing or refinement modules which undertake enrichment of the data from the uniform further-processable data structures of the data sources or the results of the combination method modules;
in that the finishing or refinement modules are symbolized on the user interface; and
in that the symbols for the finishing or refinement modules can be arranged relative to each other on the user interface in such a way that they reflect the execution of the enrichment steps.

20. Method in accordance with claim 5,
characterized
in that there are provided finishing or refinement modules which undertake enrichment of the data from the uniform further-processable data structures of the data sources or the results of the combination method modules;
in that the finishing or refinement modules are symbolized on the user interface; and
in that the symbols for the finishing or refinement modules can be arranged relative to each other on the user interface in such a way that they reflect the execution of the enrichment steps.

21. Method in accordance with claim 6,
characterized
in that there are provided finishing or refinement modules which undertake enrichment of the data from the uniform further-processable data structures of the data sources or the results of the combination method modules;
in that the finishing or refinement modules are symbolized on the user interface; and
in that the symbols for the finishing or refinement modules can be arranged relative to each other on the user interface in such a way that they reflect the execution of the enrichment steps.

22. Method in accordance with claim 2,
characterized
in that the nodes of differing type that are depicted in various colours and/or shapes can be arranged by the user in such a way that symbols, which represent the uniform further-processable data structures of the real data sources are arranged on one side of the user interface, and
in that symbols, which represent the method modules for the output to a real further processing system, are illustrated on the other side of the user interface;
in that the nodes are programmed with pre-configurations and are made available to the user on the user interface, and
in that, by modelling and shifting the nodes on the user interface, the user inserts the respectively assigned pre-configuration into the overall modelled configuration not only on the user interface, but also automatically thereby in the processing of the data;
in that there are provided filter modules which undertake filtering of the data from the uniform further-processable data structures of the data sources or the results from the combination method modules;
in that the filter modules are symbolized on the user interface;
in that the symbols for the filter modules can be arranged relative to each other on the user interface in such a way that they reflect the execution of the filtering steps;
in that there are provided finishing or refinement modules which undertake enrichment of the data from the uniform further-processable data structures of the data sources or the results of the combination method modules;
in that the finishing or refinement modules are symbolized on the user interface; and
in that the symbols for the finishing or refinement modules can be arranged relative to each other on the user interface in such a way that they reflect the execution of the enrichment steps; in that collection modules, which represent a summary of earlier or previously produced data modellings using a plurality of nodes, are provided as a type of node.
